(19) United States
(12) Patent Application Publication
(10) Pub. No.: US 2026/0088676 A1
(43) Pub. Date: Mar. 26, 2026

(54) STATOR AND ROTOR FOR AN ELECTRIC MACHINE, ELECTRIC MACHINE, METHOD FOR PRODUCING SAME, AND VEHICLE

(71) Applicant: Ford Global Technologies, LLC, Dearborn, MI (US)

(72) Inventors: Raphael Koch, Odenthal (DE); Viktor Haeuser, Burscheid (DE)

(73) Assignee: Ford Global Technologies, LLC, Dearborn, MI (US)

(21) Appl. No.: 18/896,173

(22) Filed: Sep. 25, 2024

(51) Int. Cl. H02K 3/34; B60K 1/00; B60K 7/00; H02K 3/24; H02K 3/30; H02K 3/493; H02K 15/10

(52) U.S. Cl. CPC H02K 3/345; B60K 1/00; B60K 7/0007; H02K 3/24; H02K 3/30; H02K 3/493; H02K 15/10

(57) ABSTRACT

An electric machine that includes a core and a plurality of inserts. The core includes layered electrical steel laminations. The core further includes teeth and a plurality of slots. The plurality of inserts are disposed within the plurality of slots of the core as a slot lining. Each insert includes a soft magnetic composite material.

### FIELD

The present disclosure relates to a stator and a rotor for an electric machine, such an electric machine and a method for producing electric machines. Further disclosed is an electrically powered vehicle.

### BACKGROUND

The statements in this section merely provide background information related to the present disclosure and may not constitute prior art.

The performance or power density of electric machines and their efficiency play a major role, particularly-but not only-in electromobility. Various approaches exist to optimize these parameters. For example, the torque and efficiency of electric machines can be increased by reducing the lamination thickness or by selecting high performance alloys for the electrical steel laminations. However, the consumption of resources for these measures is sometimes considerable, while the enhancements of these parameters is sometimes rather low.

The voltage level can also be increased, for example. However, the electrical insulation of the windings must be adapted for this because higher voltages require a higher insulation resistance. The thickness of the paper insulation is usually increased for this purpose, but this in turn reduces the copper fill factor in the slots.

There is therefore a need to eliminate or at least reduce the disadvantages of known systems without having to compromise on the extent of known solutions. In particular, there is a need to enhance electric machines in terms of performance/power density and efficiency.

### SUMMARY

This section provides a general summary of the disclosure and is not a comprehensive disclosure of its full scope or all of its features.

According to one form, the present disclosure provides a stator for an electric machine, which has a stator core with teeth and slots. The stator core is made of layered electrical steel laminations. An insert is arranged in each of the slots as a slot lining. The insert is made of or comprises a soft magnetic composite material. In addition, a rotor for an electric machine is provided, which comprises a rotor core with layered electrical steel laminations. The rotor core has slots and an insert is arranged in each of the slots. The insert is made of or comprises a soft magnetic composite material.

In another form, soft magnetic composite materials, also known as soft magnetic composites, can be produced from ferromagnetic powder bonded with a polymer. The ferromagnetic powder is coated here with an electrically insulating layer or embedded in a corresponding matrix and pressed or extruded to form a solid material before it is usually subjected to a final heat treatment to harden the matrix. In one form, the material is not sintered.

In yet another form, soft magnetic composites are relatively new and have a number of advantages. Unique properties include three dimensional (3D) isotropic ferromagnetic behavior, very low eddy current losses, relatively low overall losses at medium and high frequencies, opportunities for enhanced thermal properties, flexible machine design and assembly, and the prospect of significant weight reductions. In other words, the inserts can be produced particularly quickly and economically.

In one form, inserts made of soft magnetic composite material can continue to replace the conventional paper insulation of windings, as they themselves act as electrical insulation. In addition, the inserted windings are mechanically protected from the sharp-edged corners of the punched electrical steel laminations of the core during assembly. The proposed inserts made of soft magnetic composite material therefore have a number of advantages over existing solutions.

In one form, the soft magnetic powder particles may comprise a soft magnetic alloy, for example an iron cobalt alloy. Finite element simulations have shown that the use of inserts made of soft magnetic composite materials with an iron cobalt alloy results in increases in rotor torque of up to 7% or more.

According to another form, the inserts can have at least one integrated channel. The channels can be provided as cooling channels for transporting a cooling fluid, or can be used as injection channels for injecting and distributing an electrically insulating polymer into a space at least partially delimited by the respective insert. In this way, manufacture can be simplified and the performance of the electric machine can be further optimized.

According to yet another form, the inserts can have chamfered or rounded edges on at least one end face. This simplifies assembly.

In one form, the inserts can have a wall thickness that varies depending on the distance from the axis of rotation of the electric machine. For example, the wall thickness can decrease or increase with increasing distance from the axis of rotation. This allows the magnetic properties of the inserts to be adjusted as desired. The magnetic flux or magnetic flux density can thus be increased and the efficiency of the electric machine enhanced.

If the electric machine is manufactured using hairpin technology, for example, the inserts can also have an inner contour adapted to the inserted windings with at least one defined projection. The conductors inserted into the inserts can thus be tightly enclosed, held and fixed, at least in portions. The inserts thus have a damping effect on the electric machine. Unwanted vibrations, for example, can be further reduced in this way.

According to another form, the inserts may have a first soft magnetic composite material in a first region and a second soft magnetic composite material in a second region. The second soft magnetic composite material may differ from the first soft magnetic composite material. Alternatively, a non-magnetic material can be used in the second region. For example, the first region of the insert can form a slot lining, while the second region represents a magnetic slot wedge for arrangement in the slot lining or completely replaces its function as an integral part.

In this way, the magnetic properties of the regions can be adjusted to suit requirements in a particularly advantageous way.

Further provided is an electric machine with a stator and/or a rotor as described above. A method for producing an electric machine with a stator and/or a rotor as described above may comprise the following method steps: a plurality of inserts are pressed or extruded from a soft magnetic composite material; one or more of the inserts are inserted into slots of a stator and/or a rotor from a first side; optionally, one or more additional inserts can additionally be inserted into the slots from a second side; and windings and/or magnets can be inserted into the inserts before or after inserting the inserts into the slots. The windings may already be contacted or may be ready to be contacted.

According to yet another form, a vehicle with an electric machine as described above is also provided. In this context, a vehicle is understood to be a device that is configured for the transportation of objects, freight or people between different destinations. Examples of vehicles include land-based vehicles such as motor vehicles, electric vehicles, hybrid vehicles or the like, rail vehicles, aircraft or watercraft. Optionally, vehicles in the present context may be considered as road-based vehicles, such as cars, trucks, buses or the like.

In one form, the electric machine described above can be arranged in the vehicle as a front motor, mid mounted motor, underfloor motor or wheel hub motor, for example.

In variations of the vehicle of the above paragraph, which can be implemented individually or in any combination: the soft magnetic composite material comprises soft magnetic powder particles and an electrically insulating polymer, the soft magnetic powder particles having a soft magnetic alloy containing an iron cobalt alloy; each insert comprises at least one channel, the at least one channel is a cooling channel for transporting a cooling fluid or an injection channel for injecting and distributing an electrically insulating polymer into an interior space at least partially delimited by the insert; each insert has chamfered or rounded edges on at least one end face; the plurality of inserts have a wall thickness which is variable as a function of a distance from the axis of rotation of the electric machine; the wall thickness decreases or increases with increasing distance from the axis of rotation; each insert has an inner contour with at least one defined projection in order to tightly enclose at least a portion of a conductor inserted into the insert; each insert comprises a first soft magnetic composite material in a first region and comprises a second soft magnetic composite material in a second region, the first region forms a slot lining and the second region forms a magnetic slot wedge in the slot lining; and the core is a stator core or a rotor core.

All of the features described with regard to the various aspects can be combined individually or in (sub-)combinations with other aspects. Individual aspects are explained with regard to devices, others with regard to a method. However, the aspects are to be transferred mutually accordingly.

Further areas of applicability will become apparent from the description provided herein. It should be understood that the description and specific examples are intended for purposes of illustration only and are not intended to limit the scope of the present disclosure.

### DRAWINGS

The disclosure and further advantageous embodiments and developments thereof are described and explained in greater detail below with reference to the examples shown in the drawings, in which:

FIG. 1 is a cross-sectional view of electric machines according to the principles of the present disclosure;

FIG. 2 is a perspective view of the electric machine of FIG. 1;

FIG. 3 is a perspective view of an insert disposed in the electric machine of FIG. 1;

FIG. 4 is a perspective view of another insert according to the principles of the present disclosure;

FIG. 5 is a perspective view of another insert according to the principles of the present disclosure;

FIG. 6 is a perspective view of another insert according to the principles of the present disclosure;

FIG. 7 is a perspective view of another insert according to the principles of the present disclosure;

FIG. 8 is a perspective view of other inserts according to the principles of the present disclosure;

FIG. 9 is a cross-sectional view of inserts according to the principles of the present disclosure;

FIG. 10 is a cross-sectional view of inserts according to the principles of the present disclosure;

FIG. 11 is a cross-sectional view of inserts according to the principles of the present disclosure;

FIG. 12 is a cross-sectional view of inserts according to the principles of the present disclosure;

FIG. 13 is a cross-sectional view of inserts according to the principles of the present disclosure;

FIG. 14 is a perspective view of a stator of an electric machine according to the principles of the present disclosure;

FIG. 15 is a perspective view of a stator of an electric machine according to the principles of the present disclosure; and

FIG. 16 is a schematic side view of a vehicle according to the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The following detailed description in conjunction with the accompanying drawings, in which like numerals refer to like elements, is intended as a description of various forms of the disclosed subject matter and is not intended to represent the only form. Any form described in this disclosure is by way of example or for illustration only and should not be construed as preferential or advantageous over other forms. The illustrative examples contained herein are not intended to be exhaustive and do not limit the claimed subject matter to the precise forms disclosed. Various modifications of the described forms will be readily apparent to those skilled in the art, and the general principles defined herein may be applied to other forms and applications without departing from the spirit and scope of the described forms. Therefore, the described forms are not limited to the forms shown, but have the widest possible scope of application consistent with the principles and features disclosed herein.

All features disclosed below with respect to the exemplary forms and/or accompanying figures may be combined alone or in any sub combination with features of aspects of the present disclosure, including features of desired forms, provided that the resulting combination of features is expedient to a person skilled in the art.

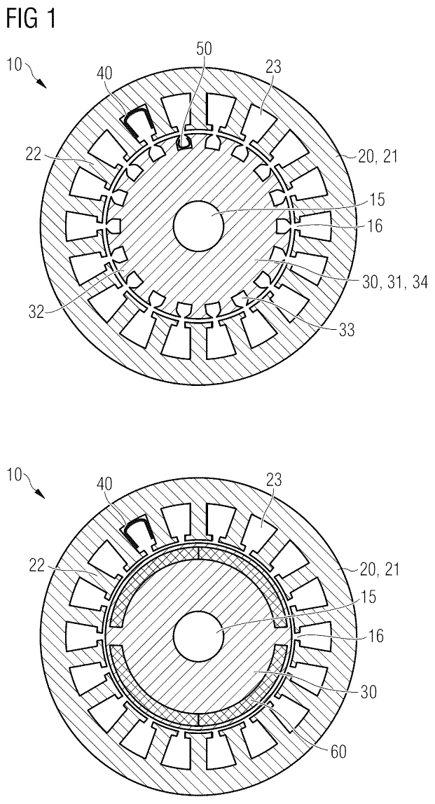

FIG. 1 shows, at the top, a cross-sectional view of an electric machine 10. A rotor 30 and a stator 20 are arranged concentrically around a shaft 15. The electric machine is an example of an asynchronous motor.

The rotor 30 comprises a rotor core 31 made of layered electrical steel laminations. The rotor 30 also has teeth 32 and slots 33. Inserts 50 made of a soft magnetic composite material are arranged in the slots 33.

The stator 20 has a stator core 21 with teeth 22 and slots 23. The stator core 21 is also made of layered electrical steel laminations.

An insert 40 is arranged in each of the slots 23 of the stator 20 as a slot lining. The insert 40 is made of a soft magnetic composite material.

The soft magnetic composite material of the inserts 40, 50 comprises soft magnetic powder particles and an electrically insulating polymer. The soft magnetic powder particles comprise a soft magnetic alloy, for example an iron cobalt alloy.

Although both the stator 20 and the rotor 30 can each have the inserts 40, 50; in alternative form, however, only the rotor 30 or only the stator 20 can comprise corresponding inserts 40, 50.

Furthermore, FIG. 1 shows, at the bottom, a further cross-sectional view of an electric machine 10. A rotor 30 and a stator 20 are arranged concentrically around a shaft 15. The electric machine is an example of a synchronous motor.

Several permanent magnets are arranged on/in the rotor 30. In alternative forms, however, the rotor 30 can also comprise electromagnets.

The stator 20 has a stator core 21 with teeth 22 and slots 23. The stator core 21 is also made of layered electrical steel laminations.

An insert 40 is arranged in each of the slots 23 of the stator 20 as a slot lining. The insert 40 is made of a soft magnetic composite material.

The soft magnetic composite material of the inserts 40 has soft magnetic powder particles and an electrically insulating polymer. The soft magnetic powder particles comprise a soft magnetic alloy, preferably an iron cobalt alloy, for example.

In principle, however, the technical teaching is not limited to electric motors or electric machines in motor mode. It can also be used in generators or electric machines in generator mode.

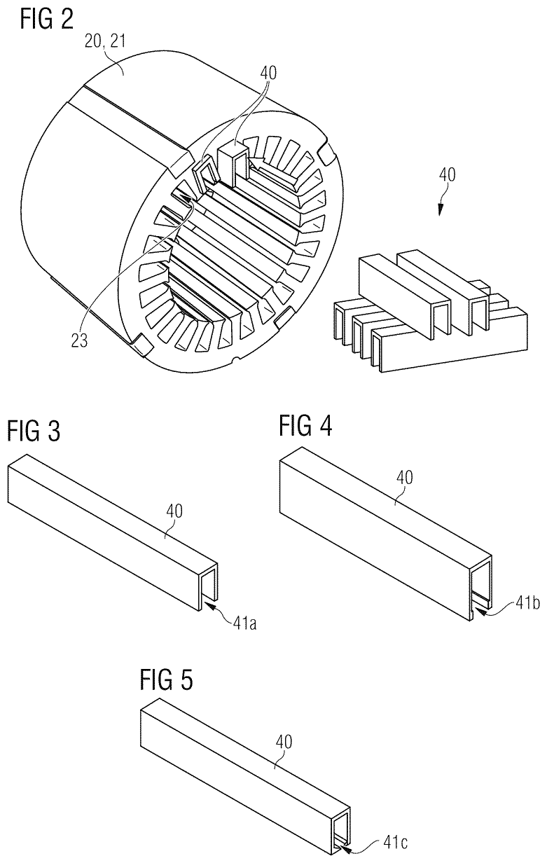

FIG. 2 shows a perspective view of the stator 20.

As part of the manufacture of an electric machine 10, corresponding inserts 40 are inserted into the slots 23 of the stator 20 as a slot lining. The inserts 40 can thus completely replace the paper insulations used in the prior art.

The rotor 30 of an electric machine can be equipped with inserts 50 in a comparable manner, even if this alternative is not shown separately hereinafter.

Also shown are further inserts 40, which have been pressed or extruded from a soft magnetic composite material and are ready for assembly.

The insert 40 shown in FIG. 3 in a perspective view has an open shape, which can also be described as a U shape in cross section, for example.

The insert 40 from FIG. 4, shown in a perspective view, in turn has a semi closed shape, which can also be described as C shape in cross section, for example. Due to the slot formed between the cover wings, the windings can be inserted into the insert 40 particularly easily if the insert 40 is sufficiently elastic.

FIG. 5 shows a perspective view of an insert 40, which has a closed shape. The cross section can therefore be described as D shaped, for example. In one variation, the insert 40 can have, on both sides, cover wings that fit closely against one another or that overlap in part.

Alternatively, the insert 40 can have a closed, tubular cross section. In this case, however, the windings must be inserted into the insert 40 from one end face.

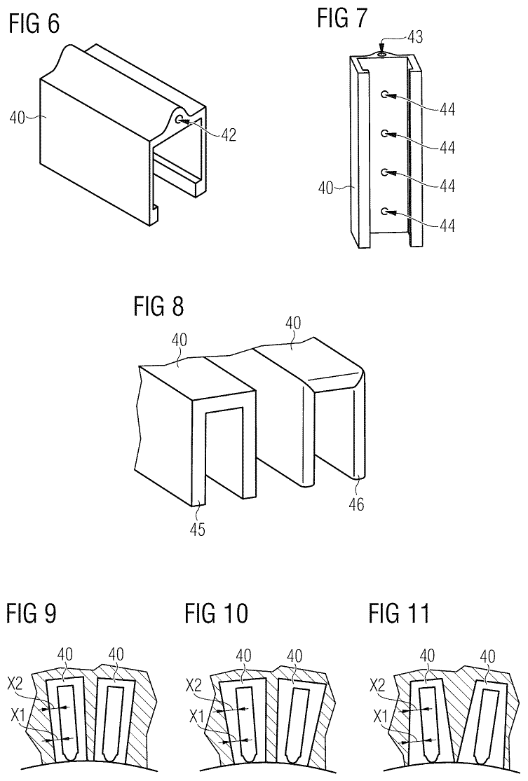

FIG. 6 shows a perspective view of a variant of an insert 40 with at least one channel 42. The channel 42 extends in a longitudinal direction along the direction in which the insert 40 extends. Such an insert 40 can be extruded particularly easily. The channel 42 is a cooling channel and is provided for transporting a cooling fluid.

FIG. 7 also shows an insert 40 with a channel 43 in a simplified perspective view. The channel 43 extends in a longitudinal direction along the insert 40. The channel 43 also has a plurality of injection openings 44, which open in the direction of the interior space at least partially bounded by the insert 40. The channel 43 can thus be used in particular for injecting into and distributing an electrically insulating polymer in the insert 40.

FIG. 8 shows two alternative variations of inserts 40 in a perspective view. While the end face 45 of the insert 40 shown on the left is flat/blunt and therefore particularly easy to manufacture, the insert 40 shown on the right can be inserted into the respective slots 23 particularly easily and without canting thanks to the chamfered/rounded edges at the end face 46.

FIGS. 9-11 show different variants of slots 23 with the associated inserts 40, each in a cross-sectional view. The inserts 40 have a wall thickness X1, X2 that varies depending on the distance from the shaft or axis of rotation of the electric machine 10. While the wall thickness of the inserts 40 in FIG. 9 is substantially constant, i.e., the wall thicknesses X1 and X2 are the same or differ only slightly from each other, the wall thickness of the inserts 40 in FIG. 10 increases with increasing distance from the axis of rotation; the wall thickness X2 further away from the axis of rotation is therefore greater than the wall thickness X1. In FIG. 11, the wall thickness of the insert 40 decreases with increasing distance from the axis of rotation of the electric machine 10, so that the wall thickness X2 measured further away from the axis of rotation is smaller than the wall thickness X1.

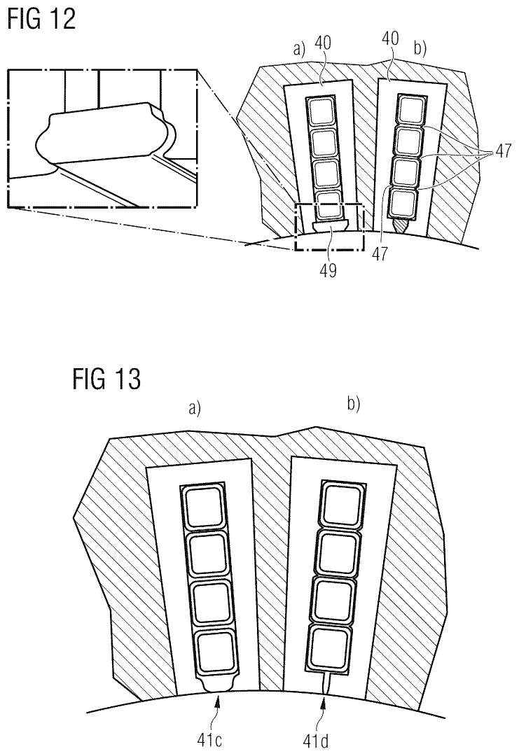

FIGS. 12 and 13, similarly to the preceding figures, show various alternative forms of inserts 40, in each case in cross-sectional views.

While an insert 40 with a slot wedge 49 is shown on the left-hand side in FIG. 12, an insert 40 is shown on the right-hand side which has a first soft magnetic composite material in a first region and a second soft magnetic composite material in a second region 48. The first region forms a slot lining, while the second region 48 assumes the function of an integrated magnetic slot wedge. In alternative variants, however, the material in the second region can also be non-magnetic.

In FIG. 13, an insert 40 is shown on the right-hand side, in which the wall thickness varies depending on the windings inserted or to be inserted. For this purpose, the insert 40 has an inner contour with at least one defined projection 47, so that the cross section of the insert 40 largely corresponds to the shape of the inserted windings and encloses them tightly, at least in portions. The insert 40 also has cover wings 41d on both sides, which fit closely together so that an additional slot wedge can be omitted.

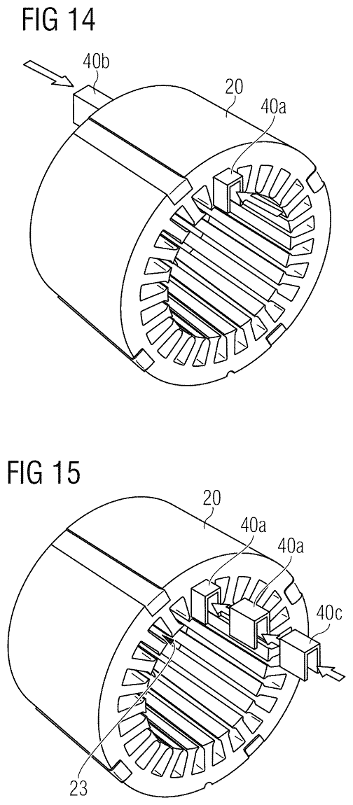

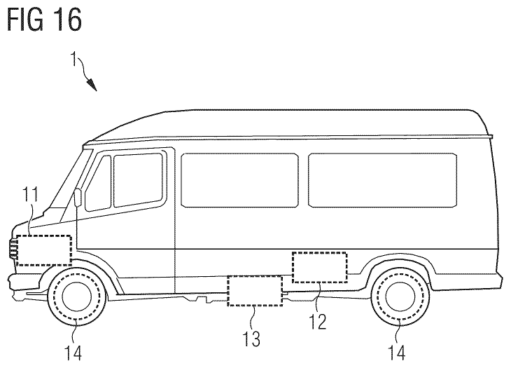

FIGS. 14 and 15 show simplified perspective views of a stator 20.

While the length of the inserts 40 in FIG. 2 substantially corresponds to the length of the stator 20 and thus fills the entire length of the associated slot 23, the inserts 40a, 40b in FIG. 14 are formed in several parts and are inserted into the stator 20 from a first and a second side during assembly. The manufacture of an electric machine 10 therefore comprises the pressing or extrusion of several inserts 40a, 40b, the insertion of one or more inserts 40a into one of the slots 23 from a first side, the insertion of one or more inserts 40b from a second side, the insertion of windings into the inserts 40a, 40b and the contacting of the windings.

In FIG. 15, the inserts 40a, 40c are also formed in several parts. However, the manufacture of an electric machine 10 here comprises the pressing or extrusion of several inserts 40a, 40c, the insertion of several inserts 40a, 40c into one of the slots 23 from one side in each case, the insertion of windings into the inserts 40a, 40c and the contacting of the windings.

The inserts can thus be manufactured in shorter lengths and inserted more easily into the associated slots 23.

FIG. 16 shows a schematic representation of a vehicle 1 in a side view. The vehicle 1 has at least one electric machine 10 as described above. The electric machine 10 can, for example, be arranged in the vehicle (1) as a front motor 11, mid mounted motor 12, underfloor motor 13 or wheel hub motor 14.

Reference may be made to quantities and numbers in the present application. Unless expressly stated, such quantities and numbers are not to be regarded as limiting, but as examples of the possible quantities or numbers in the context of the present application. In this context, the term “plurality” may also be used in the present application to refer to a quantity or number. In this context, the term “plurality” means any number greater than one, e.g., two, three, four, five, etc. The terms “about”, “approximately”, “near”, etc. mean plus or minus 5% of the stated value.

Although the disclosure has been presented and described with reference to one or more embodiments, a person skilled in the art will be able to make equivalent changes and modifications after reading and understanding this description and the accompanying drawings.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An electric machine comprising:
a core with teeth and slots, and the core comprising layered electrical steel laminations; and
a plurality of inserts disposed within slots of the core as a slot lining, each insert comprises a soft magnetic composite material.

2. The electric machine according to claim 1, wherein the soft magnetic composite material comprises soft magnetic powder particles and an electrically insulating polymer, and wherein the soft magnetic powder particles having a soft magnetic alloy containing an iron cobalt alloy.

3. The electric machine according to claim 1, wherein each insert comprises at least one channel, the at least one channel is a cooling channel for transporting a cooling fluid or an injection channel for injecting and distributing an electrically insulating polymer into an interior space at least partially delimited by the insert.

4. The electric machine according to claim 1, wherein each insert has chamfered or rounded edges on at least one end face.

5. The electric machine according to claim 1, wherein the plurality of inserts have a wall thickness which is variable as a function of a distance from the axis of rotation of the electric machine.

6. The electric machine according to claim 5, wherein the wall thickness decreases or increases with increasing distance from the axis of rotation.

7. The electric machine according to claim 1, wherein each insert has an inner contour with at least one defined projection in order to tightly enclose at least a portion of a conductor inserted into the insert.

8. The electric machine according to claim 1, wherein each insert comprises a first soft magnetic composite material in a first region and comprises a second soft magnetic composite material in a second region, and wherein the first region forms a slot lining and the second region forms a magnetic slot wedge in the slot lining.

9. The electric machine according to claim 1, wherein the core is a stator core or a rotor core.

10. A vehicle comprising at least one electric machine according to claim 1, wherein the electric machine being arranged in the vehicle as a front motor, mid mounted motor, underfloor motor or wheel hub motor.

11. The vehicle according to claim 10, wherein the soft magnetic composite material comprises soft magnetic powder particles and an electrically insulating polymer, and wherein the soft magnetic powder particles having a soft magnetic alloy containing an iron cobalt alloy.

12. The vehicle according to claim 10, wherein each insert comprises at least one channel, the at least one channel is a cooling channel for transporting a cooling fluid or an injection channel for injecting and distributing an electrically insulating polymer into an interior space at least partially delimited by the insert.

13. The vehicle according to claim 10, wherein each insert has chamfered or rounded edges on at least one end face.

14. The vehicle according to claim 10, wherein the plurality of inserts have a wall thickness which is variable as a function of a distance from the axis of rotation of the electric machine.

15. The vehicle according to claim 10, wherein the wall thickness decreases or increases with increasing distance from the axis of rotation.

16. The vehicle according to claim 10, wherein each insert has an inner contour with at least one defined projection in order to tightly enclose at least a portion of a conductor inserted into the insert.

17. The vehicle according to claim 10, wherein each insert comprises a first soft magnetic composite material in a first region and comprises a second soft magnetic composite material in a second region, and wherein the first region forms a slot lining and the second region forms a magnetic slot wedge in the slot lining.

18. The vehicle according to claim 10, wherein the core is a stator core or a rotor core.

19. A method for producing an electric machine, the method comprising:
pressing or extruding a plurality of inserts from a soft magnetic composite material;
inserting one or more first inserts into the slots of the core from a first side;
inserting windings or magnets into the inserts; and
contacting the windings.

20. The method of claim 19, further comprising inserting one or more second inserts in each of the slots of the core from a second side.
